(19) United States
(12) Patent Application Publication
(10) Pub. No.: US 2012/0144793 A1
(43) Pub. Date: Jun. 14, 2012

(54) PULL TYPE SIDE PIVOT ROTARY MOWER CONDITIONER GEARBOX

(75) Inventors: Stanley Clark, Hesston, KS (US); Dwight Nickel, Newton, KS (US)

(73) Assignee: AGCO CORPORATION, Duluth, GA (US)

(21) Appl. No.: 13/314,604

(22) Filed: Dec. 8, 2011

Related U.S. Application Data
(60) Provisional application No. 61/420,884, filed on Dec. 8, 2010.

(51) Int. Cl. A01D 34/00

(52) U.S. Cl. 56/10.1

(57) ABSTRACT

In one embodiment, an apparatus, comprising: a pull-type implement having a top surface; a tongue assembly pivotably mounted to the pull-type implement; and a gearbox assembly mounted on the top surface and offset from the center of the top surface, the gearbox assembly comprising: a top gearbox unit rotatably coupled to a driveline via a joint that is functionally distinct from a constant velocity (CV) joint, the top gearbox unit pivotably coupled to the tongue assembly; and a bottom gearbox unit in pivotal relationship with the top gearbox unit.

### RELATED APPLICATION

Under provisions of 35 U.S.C. §119(e), Applicant claims the benefit of U.S. Provisional Application No. 61/420,884 filed Dec. 8, 2010, which is incorporated herein by reference.

### TECHNICAL FIELD

The present disclosure generally relates to steering mechanisms for pull-type implements.

### BACKGROUND

A pull-type implement is generally towed by a tractor through the use of a hitch and tongue assembly. Such tongue assemblies may be operated in a manner that enables the tongue angle to swing over a defined angle range based on the movement of the tractor. For instance, pull-type side pivot rotary mower conditions may utilize unique, complex gearbox designs to accommodate the operational tongue angle swings from field operation to turning and transport positions.

### SUMMARY

In one embodiment, an apparatus, comprising: a pull-type implement having a top surface; a tongue assembly pivotably mounted to the pull-type implement; and a gearbox assembly mounted on the top surface and offset from the center of the top surface, the gearbox assembly comprising: a top gearbox unit rotatably coupled to a driveline via a joint that is functionally distinct from a constant velocity (CV) joint, the top gearbox unit pivotably coupled to the tongue assembly; and a bottom gearbox unit in pivotal relationship with the top gearbox unit.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram that illustrates a side-elevation, partial cut-away view of a typical rearward tractor portion and a pull-type implement in which an embodiment of a gearbox assembly may be utilized.

FIG. 2 is a schematic diagram of a plan view of the pull-type implement illustrating the tongue and gearbox assembly positions through various tongue swings.

FIG. 3 is a perspective view of an embodiment of a gearbox assembly.

### DETAILED DESCRIPTION

Certain embodiments of a gearbox assembly and systems and apparatuses utilizing the same are disclosed. One embodiment of an example apparatus comprises a pull-type implement comprising a header that houses plural components, including a rotary cutter assembly, mower conditioner assembly, among other components. The header comprises a gearbox assembly mounted thereon in a location that is offset from the center of the header. The gearbox assembly comprises a lower right-angle gearbox and an upper, right angle gearbox that swivels about an upright axis relative to the lower, right angle gearbox. The upper and lower right angle gearboxes share a common upright drive shaft that couples power delivered from a power take-off (PTO) via a driveline assembly comprising plural, non-constant velocity (CV) joints to plural outputs that drive the header components. The gearbox assembly further comprises a bracket assembly that at least partially encases (e.g., partially surrounds) at least one of the non-CV joints of the driveline assembly, the bracket assembly comprising plural sub-brackets or bracket members (e.g., first and second bracket members) that are in pivotal relationship with each other. The bracket assembly comprises a telescoping assembly that facilitates a swinging movement of a tongue assembly as the gearbox assembly pivots left and right.

Digressing briefly, current pull-type implements and associated components utilize unique and expensive solutions to accommodate tongue angle swings. For instance, some implementations require complex CV joints on the input of the gearbox to reliably accommodate the tongue angular movement. Certain center pivot rotary mower conditioners utilize a similar CV-based design on the front end of the tongue to accommodate severe turning angles of the tractor/implement interface. In contrast, certain embodiments disclosed herein utilize a stacked, swivel gearbox to enable a common gearbox design and one or more non-CV joints (e.g., U-joint design) in place of a complex gearbox and CV joint. Hence, existing, off-the-shelf (e.g., standard) gearboxes may be utilized, enabling a simpler driveline design among other benefits as will be apparent from the disclosure that follows.

The following detailed description refers to the accompanying drawings. Wherever possible, the same reference numbers are used in the drawings and the following description to refer to the same or similar elements. While certain embodiments of the disclosure may be described, modifications, adaptations, and other implementations are possible as should be understood by one having ordinary skill in the art in the context of the disclosure. For example, substitutions, additions, or modifications may be made to the elements illustrated in the drawings. References hereinafter made to certain directions, such as, for example, “front”, “rear”, “left” and “right”, are made as viewed from the rear of the combine harvester looking forwardly.

Although described in the context of a system comprising a tractor and a pull-type implement comprising a mower conditioner, it should be understood by one having ordinary skill in the context of the present disclosure that other equipment may be substituted to equal or substantially equal effect. Further features and/or variations may be provided in addition to those set forth herein.

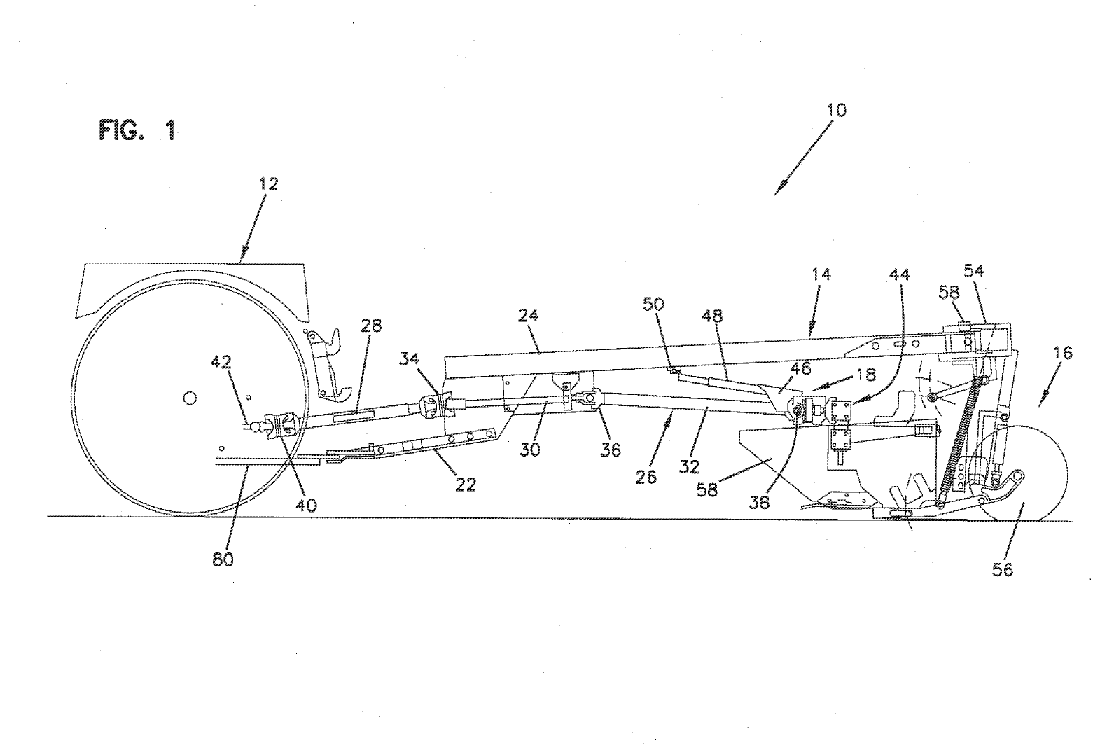

Referring to FIGS. 1-3, and in particular, FIG. 1, shown is a schematic diagram that illustrates a side-elevation, partial cut-away view of a typical rearward tractor portion and a pull-type implement in which an embodiment of a gearbox assembly may be utilized. It should be understood by one having ordinary skill in the art, in the context of the present disclosure, that the example components illustrated in FIGS. 1-3 are merely illustrative, and should not be construed as implying any limitations upon the scope of the disclosure. In particular, shown in FIG. 1 is a farm implement system 10 that illustrates a rearward portion of a tractor 12 (illustrated partially with a wheel and frame and select components) coupled to a tongue assembly 14, the tongue assembly coupled to a pull-type implement 16. In one embodiment, the pull-type implement 16 comprises one or more rotary cutters and mower conditioning components as are known in the art, and hence the discussion of the same is omitted here for brevity. The farm implement system 10 further comprises a gearbox assembly 18 mounted on the pull-type implement 16, as explained further below. The tractor 12 comprises a hitch 20 that couples to a hitch assembly 22 in known manner.

In one embodiment, the tongue assembly 14 comprises a tongue 24 and the hitch assembly 22, the tongue 24 at least partially supporting a driveline 26 that couples power from a PTO of the tractor 12 to the gearbox assembly 18. The driveline 26 may be segmented into component driveline sections or segments, including driveline segments 28, 30, and 32. Each of the segments 28, 30, and 32 of the driveline 26 are operably coupled to one another via non-CV joints 34, 36, 38, and 40. In one embodiment, the non-CV joints comprise U-joints, though other non-CV joints (e.g., that operate in a manner functionally distinct from CV joints) are contemplated to be within the scope of the disclosure. In some embodiments, one or more of the joints may utilize a CV-type joint. Segment 28 is coupled to a shaft 42 (portion shown) of the PTO via joint 40, and segment 32 is coupled to a swivel gearbox pair 44 of the gearbox assembly 18 via joint 38. In one embodiment, the gearbox assembly 18 further comprises a bracket assembly 46 that at least partially encases or surrounds the joint 38 and includes a telescoping assembly 48 comprising a first member in slidable relationship to a second member located within, the second member coupled to the tongue 24 via connection 50 according to known connection mechanisms and to the bracket 46 via known connection mechanisms (including via a welded connection).

In one embodiment, the gearbox assembly 18, and in particular, the swivel gearbox pair 44, is mounted to a top surface of a header 52. The swivel gearbox pair 44 may be mounted in a location on the top of the header 50 that is offset from a center (e.g., centerline in a direction of travel) of the header 50. The pull-type implement 16 further comprises an actuator assembly 54 that couples to the tongue 24, and plural wheels 56 (the rear, left-hand side wheel shown), though other mechanism of ground engagement are contemplated (e.g., tracks, etc.). The pull-type implement 16 further comprises a pivot connection 58 that defines an axis of rotation about a vertical or nearly vertical direction, the pivot connection 58 in cooperation with the actuator assembly 54 and the gearbox assembly 18 facilitating rotation of the tongue 24 and hence steering functionality of the pull-type implement 16.

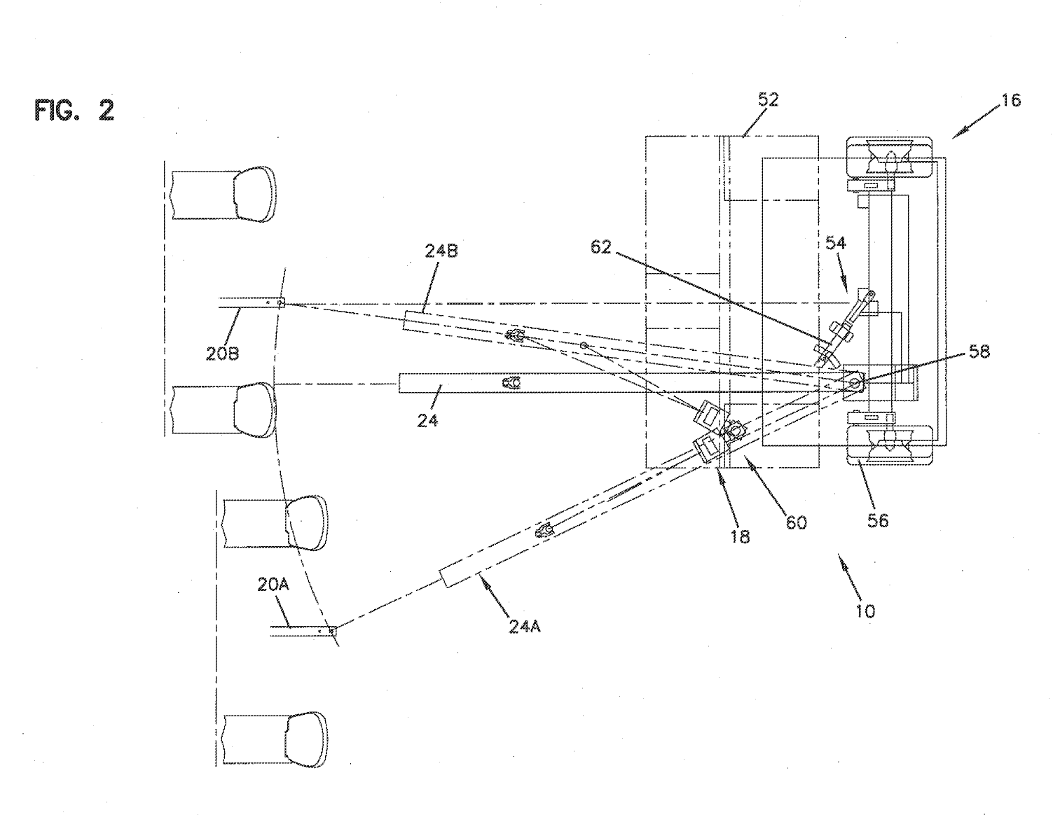

Referring to FIG. 2, select portions of the farm implement system 10 of FIG. 1 are shown in plan view to illustrate an example range of swing of the tongue 24 as well as the location of the gearbox assembly 18 on the top surface of the header 52. In particular, the gearbox assembly 18 functions along with the actuator assembly 54 as a steering mechanism for the pull-type implement 16, and different relative locations/positions of the tractor 12 (represented by the hitches 20A and 20B), tongue 24 (as noted by the tongue 24, 24A, and 24B), and gearbox assembly 18 are illustrated throughout this example range of motion. The gearbox assembly 18 is mounted on a top surface of the header 52, located in the illustrated embodiment in a location 60 proximal to, but within the confines of, the left-hand side border or edge of the header 52 as shown. In other words, the header 52 comprises a defined width running transversely (e.g., left-to-right) to the direction of travel, and the gearbox assembly 18 is located proximal to one end (in this example, the left-hand side) of the width in the transverse direction, and hence offset from a center of the header 52, yet without adding to (e.g., extending) the width of the header 52. In one embodiment, the location 60 is such that the gearbox assembly 18 does not extend the width of the header 52. In contrast, typical side-pivot gearbox assemblies are mounted to the side of the header (or mounted in a manner with equivalent effect), hence effectively extending the width of the header and possibly obstructing the range of the swing motion. However, in some embodiments, a width-extending side-mounted gearbox assembly may be utilized. In some embodiments, different locations (e.g., right-hand side, etc.) offset from the center of the header 52 may be utilized for placement of the gearbox assembly 18.

Recapping from above, in some embodiments, the range of motion may be different depending at least in part on the location 60 of the gearbox assembly 18. Note that tongues 24A and 24B are noted in phantom to illustrate the example swing range of the tongue 24. The gearbox assembly 18 likewise is shown partially in phantom as it swivels to achieve the illustrated range of motion of the tongue 24. A baseline position of the tongue 24 is illustrated as a solid line. Toward one end of the swing range, the gearbox assembly 18 (the rotated view noted in phantom) pivots about a vertical axis and is followed by the driveline segment 32 and the telescoping assembly 48, enabling the tongue 24B and pull-type implement 16 to pivot (e.g., as powered by the actuator assembly 54) about the pivot connection 58 and veer slightly to the left relative to the hitch 20B. Toward an opposite end of the swing range, the gearbox assembly 18 pivots about a vertical axis and is followed by the driveline segment 32 and the telescoping assembly 48, enabling the tongue 24A and pull-type implement 16 to pivot about the pivot connection 58 and veer to the right relative to the hitch 20A. Swing ranges in between the illustrated extreme range positions is contemplated and handled similarly, hence discussion of these intermediate ranges is omitted for brevity. As noted above, the swing movement of the tongue 24 is enabled by the actuator (e.g., hydraulic) actuator 62 of the actuator assembly 54 and facilitated by a pivoting action about the pivot connection 58. Note that the position of the tongue 24A and gearbox assembly 18 are such that the driveline 26 is coincident with the tongue 24A.

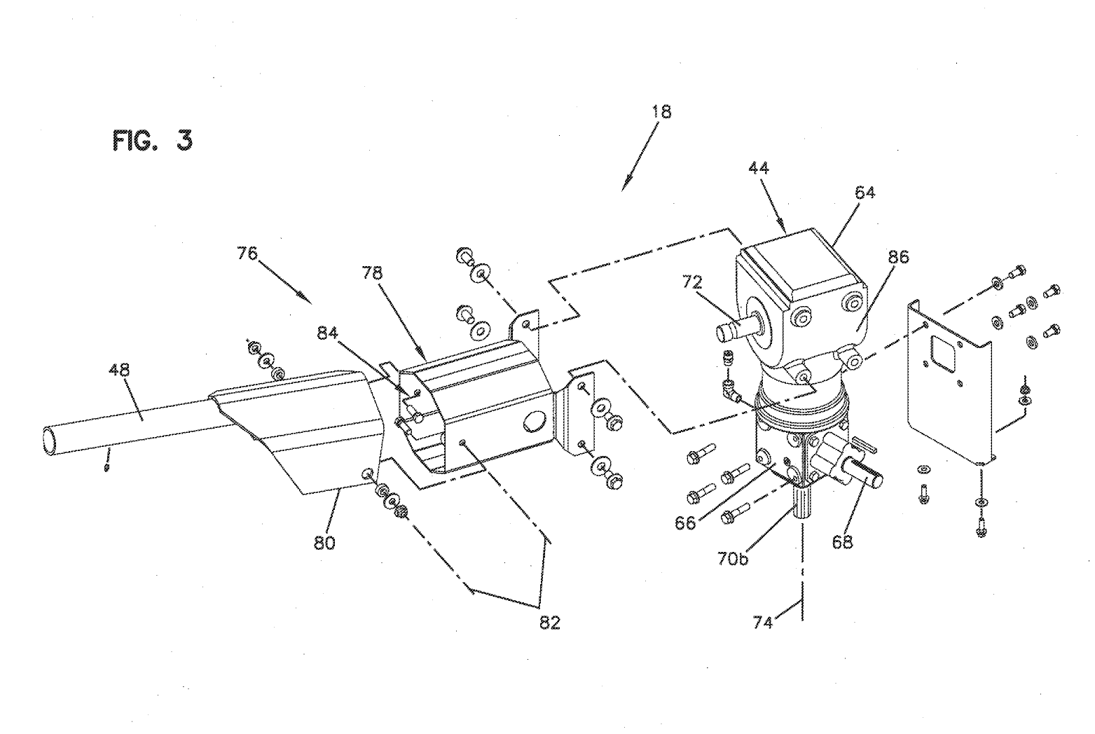

FIG. 3 illustrates an embodiment of the gearbox assembly 18. The gearbox assembly 18 comprises a swivel gearbox pair 44 comprising a top or upper right angle (e.g., ninety-degree) gearbox 64 (e.g., top gearbox unit) and a bottom or lower right angle (e.g., ninety-degree) gearbox 66 (e.g., bottom gearbox unit). The lower right angle gearbox 66 and upper right angle gearbox 64 share a common, upright drive shaft (not shown) housed within an intermediate collar so that the output of upper right angle gearbox 64 is received as input by the lower right angle gearbox 66. The lower right angle gearbox 66 comprises plural outputs or output shafts 68 and 70 located perpendicular to each other, and at least one of the outputs 68 is perpendicular to the internal common drive shaft. For instance, output shaft 68 operably couples to a rotary cutter assembly in the header 52 and the output shaft 70 operably couples to a mower conditioner assembly in the header 52. The upper right angle gearbox 64 comprises an input or input shaft 72 that operably couples to the driveline 26 via joints such as joint 38, and is at a right angle to the internal common drive shaft. The upper right angle gearbox 64 swivels (relative to the lower right angle gearbox 66 located beneath the upper right angle gearbox 64) about an upright (e.g., vertical) axis 74 that is common to the axis of rotation of the internal drive shaft between the two gearboxes 64,66. In one embodiment, the gearboxes 64 and 66 of the swivel gearbox pair 44 may be obtained as a fully assembled unit from Comer S.p.A. of Reggio Emilia, Italy. A suitable Comer unit is available as pull-through swivel gearbox Model T-279D.

The gearbox assembly 18 further comprises a bracket assembly 76. The bracket assembly 76 comprises a first bracket member 78 and a second bracket member 80 pivotably coupled to each other via pivot coupling mechanisms 82. The first bracket member 78 is of generally an octagonal geometric structure through which is defined a passage 84. Note that other geometric configurations are contemplated that enable the passage of the driveline segment (e.g., segment 32) and encasement of the joint 38. The first and second bracket member 78, 80 surround or encase (or partially encase) the segment 32 of the driveline 26, joint 38, and the input shaft 72. The first bracket member 78 is fixably attached (e.g., via bolts) to opposing faces 86 (one shown) of the upper right angle gearbox 64. The second bracket member 80 is pivotable (e.g., in the upwards and downwards direction) relative to the first bracket member 78 and, in one embodiment, partially overlaps a portion of the first bracket member 78 to enable pivotal connection thereto by pivot coupling mechanisms 82. The second bracket member 802 further includes (and encases in part) the telescoping assembly 48 coupled thereto (e.g., via known attachment mechanisms, including a welded assembly), the make-up of which is as described above.

It should be emphasized that the above-described embodiments of the present disclosure are merely possible examples of implementations, merely set forth for a clear understanding of the principles of the gearbox assembly 18 and associated apparatus and systems. Many variations and modifications may be made to the above-described embodiment(s) without departing substantially from the spirit and principles of the disclosure. Although all such modifications and variations are intended to be included herein within the scope of this disclosure and protected by the following claims, the following claims are not necessarily limited to the particular embodiments set out in the description.

What is claimed is:

1. An apparatus, comprising:
a pull-type implement having a top surface;
a tongue assembly pivotably mounted to the pull-type implement; and
a gearbox assembly mounted on the top surface and offset from the center of the top surface, the gearbox assembly comprising:
a top gearbox unit rotatably coupled to a driveline via a joint that is functionally distinct from a constant velocity (CV) joint, the top gearbox unit pivotably coupled to the tongue assembly; and
a bottom gearbox unit in pivotal relationship with the top gearbox unit.

2. The apparatus of claim 1, wherein the gearbox assembly comprises an input shaft and two output shafts, the input shaft coupled to the joint.

3. The apparatus of claim 2, wherein one of the output shafts is operably coupled to a rotary cutter of the pull-type implement.

4. The apparatus of claim 2, wherein one of the output shafts is operably coupled to a conditioner of the pull-type implement.

5. The apparatus of claim 1, wherein the gearbox assembly comprises a bracket assembly comprising a first bracket member and a second bracket member in pivotal relationship with the first bracket member.

6. The apparatus of claim 5, wherein the first bracket member is fixably attached to the top gearbox unit.

7. The apparatus of claim 5, wherein the second bracket member comprises a telescoping assembly coupled thereto, the telescoping assembly comprising a first member at least partially encased by a hollow second member, the telescoping assembly coupled to the tongue assembly.

8. The apparatus of claim 5, wherein the bracket assembly at least partially encases the joint.

9. The apparatus of claim 1, wherein the top gearbox unit operates substantially similar to the bottom gearbox unit.

10. The apparatus of claim 1, wherein the top gearbox unit and the bottom gearbox unit each comprise ninety-degree gearbox units.

11. The apparatus of claim 1, wherein the gearbox assembly is configured to provide at least in part steering functionality for the pull-type implement.

12. The apparatus of claim 1, wherein the pull-type implement comprises a header containing the top surface and a width that is transverse to a direction of travel of the pull-type implement, the width having first and second opposing edges defining the width in the transverse direction, wherein the offset is closer to the first edge than to a center of the header.

13. A farm implement system, comprising:
a vehicle comprising a power take-off (PTO) shaft and a hitch, the PTO shaft coupled to a driveline;
a pull-type implement having a header;
a tongue assembly having first and second ends, the first end coupled to the hitch and the second end pivotably mounted to the pull-type implement, the tongue assembly at least partially suspending the driveline; and
a gearbox assembly mounted to the header in a location that is offset from the center of the header, the offset in a direction transverse to a direction of travel of the pull-type implement, the gearbox assembly comprising:
a first gearbox unit rotatably coupled to the driveline via a joint that is functionally distinct from a constant velocity (CV) joint, the first gearbox unit pivotably coupled to the tongue assembly; and
a second gearbox unit in pivotal relationship with the first gearbox unit.

14. The system of claim 13, wherein the gearbox assembly comprises an input shaft and plural output shafts, the input shaft coupled to the joint.

15. The system of claim 14, wherein a first of the output shafts is operably coupled to a rotary cutter of the pull-type implement and a second of the output shafts is coupled to a conditioner of the pull-type implement.

16. The system of claim 13, wherein the gearbox assembly comprises a bracket assembly, the bracket assembly comprising a first bracket member and a second bracket member in pivotal relationship with the first bracket member, wherein the bracket assembly at least partially encases the joint.

17. The system of claim 16, wherein the first bracket member is fixably attached to the top gearbox unit.

18. The system of claim 17, wherein the second bracket member comprises a telescoping assembly coupled thereto, the telescoping assembly comprising a first member at least partially surrounded by a hollow second member, the telescoping assembly coupled to the tongue assembly.

19. The system of claim 18, wherein the first gearbox unit and the second gearbox unit each comprise ninety-degree gearbox units that are substantially similar.

20. An apparatus coupled to a pull-type implement, comprising:
a gearbox assembly mounted on a top surface of a header of the pull-type implement and offset from a center of the top surface in a location from the center that is transverse to a direction of travel, the gearbox assembly comprising:
a top right-angle gearbox unit rotatably coupled to a driveline via a joint that is functionally distinct from a constant velocity (CV) joint, the top gearbox unit pivotably coupled to a tongue assembly that at least partially supports the driveline;
a bottom right-angle gearbox unit in pivotal relationship with the top gearbox unit, the top right-angle gearbox unit substantially similar in function to the bottom right-angle gearbox unit; and
a bracket assembly that at least partially encases the joint, the bracket assembly comprising a first bracket member and a second bracket member in pivotal relationship with the first bracket member, the first bracket member fixably attached to the top gearbox unit, the second bracket member comprising a telescoping assembly coupled thereto, the telescoping assembly comprising a first member at least partially encased by a hollow second member, the telescoping assembly coupled to the tongue assembly.
